(19) United States
(12) Patent Application Publication
(10) Pub. No.: US 2009/0147875 A1
(43) Pub. Date: Jun. 11, 2009

(54) RADIO TRANSMITTER AND RADIO RECEIVER

(76) Inventors: Koji Akita, Yokohama-shi (JP); Kaoru Inoue, Machida-shi (JP); Ren Sakata, Yokoyama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/368,682

(22) Filed: Feb. 10, 2009

Related U.S. Application Data
(63) Continuation of application No. PCT/JP08/64079, filed on Jul. 30, 2008.

(30) Foreign Application Priority Data
Sep. 28, 2007 (JP) 2007-256523

(51) Int. Cl. H04L 27/28; H04L 27/00; H04B 3/46

(52) U.S. Cl. 375/260; 375/295; 375/316; 375/345; 375/224

(57) ABSTRACT

A radio transmitter includes a unit which generates a first instruction to instruct the transmission of a first transmission signal, a unit which generates the first transmission signal based on the first instruction, a unit which generates a second instruction to instruct the transmission of a second transmission signal to be selectively multiplied by an orthogonal code, a unit which generates the second transmission signal based on the second instruction, unit which transmits the first and the second transmission signals, a unit which predicts a collision of the first and second transmission signals, and a unit which stops the first transmission signal while the collision is predicted in a case where the second transmission signal is multiplied by the orthogonal code and which stops the second transmission signal while the collision is predicted in a case where the second transmission signal is not multiplied by the orthogonal code.

### CROSS-REFERENCE TO RELATED APPLICATIONS

This is a Continuation Application of PCT Application No. PCT/JP2008/064079, filed Jul. 30, 2008, which was published under PCT Article 21(2) in English.

This application is based upon and claims the benefit of priority from prior Japanese Patent Application No. 2007-256523, filed Sep. 28, 2007, the entire contents of which are incorporated herein by reference.

### BACKGROUND OF THE INVENTION

1. Field of the Invention

This invention relates to a radio transmitter and a radio receiver which transmit and receive a plurality of signals.

2. Description of the Related Art

When a radio communication device is designed, peak to average ratio (PAPR) characteristics of a radio signal to be transmitted are considered to be important. The PAPR indicates a ratio of the peak power to the average power of the signal. As the ratio increases, the requirement specification of a power amplifier becomes more severe. In recent years, a multi carrier signal, such as one subject to orthogonal frequency division multiplexing (OFDM) signal, is frequently used in radio communication. When the multi carrier signal is used, broad-band radio communication can efficiently be performed. However, the multi carrier signal has a problem that the PAPR is high. On the other hand, a single carrier signal which has been conventionally used from a long time ago has characteristics that the PAPR can be lowered.

Therefore, in the 3rd generation partnership project (3GPP), the application of the single carrier signal to uplink communication in cellular communication is investigated. Furthermore, in the system investigated in 3GPP, a method of multiplexing, in a frequency direction, the single carrier signals transmitted from a plurality of users is investigated. That is, even when each of the single carrier signals has a narrow band, these signals are multiplexed in the frequency direction, so that they become a broad-band signal as a whole. A base station then receives the signal which had been made broad-band in this manner.

However, when a plurality of single carrier signals are simultaneously transmitted, they eventually become a multi carrier signal, and the increase of the PAPR is caused. For example, in the system investigated in 3GPP, there is a physical uplink control channel (PUCCH) as a channel which is used to send a control signal, and a sounding reference signal (SRS) as a signal which is used to measure an uplink channel. Both the PUCCH and the SRS are single carrier signals, but when these signals are simultaneously transmitted, they become a multi carrier signal.

To solve this problem, according to R1-073092, “Sounding RS Multiplexing in E-UTRA UL-Interaction with PUCCH”, Samsung, a method is suggested in which the transmission of one of two transmission signals is stopped, when it is instructed to simultaneously transmit two transmission signals, that is, when the collision of the two transmission signals is predicted. More specifically, a method is suggested in which only a portion of the one transmission signal which temporally overlaps with the other transmission signal is stopped. In consequence, the increase of the PAPR can be prevented.

In the technology disclosed in R1-073092, “Sounding RS Multiplexing in E-UTRA UL-Interaction with PUCCH”, Samsung, when the one transmission signal is stopped, the stopped transmission signal sometimes exerts an adverse influence. For example, when the PUCCH is stopped, a receiving performance deteriorates, and there occurs a problem that control information is not normally transmitted to the base station. In particular, when the PUCCH is multiplied by an orthogonal code and the signal of a part of the PUCCH is stopped, the orthogonality of the multiplied orthogonal code is not maintained, which leads to a problem of serious performance degradation.

On the other hand, when the SRS is stopped, uplink channel estimation is not normally performed. As a result, there occurs a problem that the precision of processing to be performed using a channel estimation result, for example, scheduling of each user, transmission power control and timing control deteriorates.

In general, the channel gradually fluctuates with time. Therefore, if the SRS stops only for a short period, the channel estimation can be complemented with the past channel estimation result. However, stopping the SRS over a long period results in a large degradation of the channel estimation precision, which causes a large problem in various types of processing to be performed using the channel estimation result.

Thus, in the conventional technology, when the collision of two transmission signals is predicted, the one of the transmission signals is stopped in a fixed manner. Therefore, when the PUCCH is stopped, the performance of the PUCCH noticeably deteriorates sometimes. When the SRS is stopped, the SRS is continuously stopped over a long period, which can noticeably deteriorate the channel estimation precision.

An object of this invention is to avoid such increase of the PAPR and to alleviate an adverse effect due to the stopping of one of the two transmission signals.

More specifically, in a case where, for example, the PUCCH signal and the SRS are transmitted as the two transmission signals, an object of the present invention is to avoid the large degradation of the performance of the PUCCH and to decrease the continuous stopping of the SRS over a long period.

### BRIEF SUMMARY OF THE INVENTION

According to a first aspect of the present invention, there is provided a radio transmitter comprising: a first instruction unit which generates a first instruction signal to instruct the transmission of a first transmission signal; a first generation unit which generates the first transmission signal based on the first instruction signal; a second instruction unit which generates a second instruction signal to instruct the transmission of a second transmission signal to be selectively multiplied by an orthogonal code; a second generation unit which generates the second transmission signal based on the second instruction signal; a transmission unit which transmits the first transmission signal and the second transmission signal; a collision prediction unit which predicts the collision of the first transmission signal with the second transmission signal based on the first instruction signal and the second instruction signal; and a signal stop unit which stops the first transmission signal while the collision is predicted in a case where the second transmission signal is multiplied by the orthogonal code and which stops the second transmission signal while the collision is predicted in a case where the second transmission signal is not multiplied by the orthogonal code.

According to a second aspect of the present invention, there is provided a radio transmitter comprising: a first instruction unit which generates a first instruction signal to instruct the transmission of a first transmission signal; a first generation unit which generates the first transmission signal based on the first instruction signal; a second instruction unit which generates a second instruction signal to instruct the transmission of a second transmission signal to be selectively multiplied by an orthogonal code; a second generation unit which generates the second transmission signal based on the second instruction signal; a transmission unit which transmits the first transmission signal and the second transmission signal; a collision prediction unit which predicts the collision of the first transmission signal with the second transmission signal based on the first instruction signal and the second instruction signal; and an amplitude adjustment unit which decreases the amplitude of the first transmission signal while the collision is predicted in a case where the second transmission signal is multiplied by the orthogonal code and which decreases the amplitude of the second transmission signal while the collision is predicted in a case where the second transmission signal is not multiplied by the orthogonal code.

According to a third aspect of the present invention, there is provided a radio receiver comprising: a reception unit which receives a signal transmitted from the radio transmitter according to the first aspect to obtain a received signal; a signal separation unit which separates the received signal into a first transmission signal and a second transmission signal; a first transmission signal demodulation unit which demodulates the separated first transmission signal; a dummy signal insertion unit which inserts a dummy signal into the stop period of the separated second transmission signal during the stop period of the second transmission signal to output the signal and which outputs the separated second transmission signal during the non-stop period of the second transmission signal; and a second transmission signal demodulation unit which demodulates the second transmission signal or the dummy signal output from the dummy signal insertion unit.

According to a fourth aspect of the present invention, there is provided a radio receiver comprising: a reception unit which receives a signal transmitted from the radio transmitter according to the second aspect to obtain a received signal; a signal separation unit which separates the received signal into a first transmission signal and a second transmission signal; a first demodulation unit which demodulates the separated first transmission signal; an amplitude correction unit which corrects the amplitude of the separated second transmission signal to output the signal while the amplitude of the second transmission signal is decreased and which outputs the separated second transmission signal as it is while the amplitude of the second transmission signal is not decreased; and a second demodulation unit which demodulates the second transmission signal output from the amplitude correction unit.

According to a fifth aspect of the present invention, there is provided a radio receiver comprising: a reception unit which receives a signal transmitted from the radio transmitter according to the second aspect to obtain a received signal; a signal separation unit which separates the received signal into a first transmission signal and a second transmission signal; a first amplitude correction unit which corrects the amplitude of the separated first transmission signal to output the signal while the amplitude of the first transmission signal is decreased and which outputs the separated second transmission signal as it is while the amplitude of the first transmission signal is not decreased; a first demodulation unit which demodulates the first transmission signal output from the first amplitude correction unit; a second amplitude correction unit which corrects the amplitude of the separated second transmission signal to output the signal while the amplitude of the second transmission signal is decreased and which outputs the separated second transmission signal as it is while the amplitude of the second transmission signal is not decreased; and a second demodulation unit which demodulates the second transmission signal output from the second amplitude correction unit.

### BRIEF DESCRIPTION OF THE SEVERAL VIEWS OF THE DRAWING

FIG. 1 is a block diagram showing a radio transmitter according to a first embodiment;

FIG. 2 is a block diagram showing a specific example of a signal stop unit in FIG. 1;

FIG. 3 is a diagram showing an example of the allocation of a first transmission signal and a second transmission signal;

FIG. 4 is a diagram showing an example of the collision of the first transmission signal with the second transmission signal;

FIG. 5 is a diagram showing an example of the collision of the first transmission signal with the second transmission signal;

FIG. 6 is a diagram showing an example of the allocation of the first transmission signal and the second transmission signal;

FIG. 7 is a diagram showing an example of the collision of the first transmission signal with the second transmission signal;

FIG. 8 is a diagram showing an example of the collision of the first transmission signal with the second transmission signal;

FIG. 9 is a block diagram showing a radio transmitter according to a modification of the first embodiment;

FIG. 10 is a block diagram showing a first specific example of a signal stop unit in FIG. 9;

FIG. 11 is an explanatory diagram regarding the continuous stop of the first transmission signal;

FIG. 12 is an explanatory diagram regarding the continuous stop of the first transmission signal;

FIG. 13 is an explanatory diagram regarding the continuous stop of the first transmission signal;

FIG. 14 is a block diagram showing a second specific example of the signal stop unit in FIG. 9;

FIG. 15 is an explanatory diagram regarding the influence of an orthogonal code;

FIG. 16 is an explanatory diagram regarding the influence of the orthogonal code;

FIG. 17 is a block diagram showing a radio transmitter according to a second embodiment;

FIG. 18 is a block diagram showing a specific example of a signal amplitude adjustment unit in FIG. 17;

FIG. 19 is a block diagram showing a modification of the radio transmitter according to the second embodiment;

FIG. 20 is a block diagram showing a first specific example of an amplitude adjustment unit in FIG. 19;

FIG. 21 is a block diagram showing a first specific example of the amplitude adjustment unit in FIG. 19;

FIG. 22 is a block diagram showing a radio receiver according to a third embodiment;

FIG. 23 is a block diagram showing a radio receiver according to a fourth embodiment; and

FIG. 24 is a block diagram showing a modification of the radio receiver according to the third embodiment.

### DETAILED DESCRIPTION OF THE INVENTION

Hereinafter, the present embodiment will be described in detail with reference to the drawings.

### First Embodiment

As shown in FIG. 1, a radio transmitter according to the first embodiment of the present invention includes a first transmission instruction unit 101, a second transmission instruction unit 102, a collision prediction unit 103, a signal stop unit 104, a first transmission signal generation unit 105, a second transmission signal generation unit 106, a combining unit 107, a radio unit 108 and an antenna 109.

The first transmission instruction unit 101 supplies, to the first transmission signal generation unit 105, a first instruction signal 111 to instruct the transmission of a first transmission signal. The second transmission instruction unit 102 supplies, to the second transmission signal generation unit 106, a first instruction signal 112 to instruct the transmission of a second transmission signal. On receiving the first instruction signal 111, the first transmission signal generation unit 105 generates the first transmission signal. On receiving the second instruction signal 112, the second transmission signal generation unit 106 generates the second transmission signal.

Here, the second transmission signal generated by the second transmission signal generation unit 106 is selectively multiplied by an orthogonal code. In the present embodiment, information on whether or not the second transmission signal is multiplied by the orthogonal code is included in, for example, the second instruction signal 112.

The first transmission signal and the second transmission signal are combined into one signal by the combining unit 107. An output signal from the combining unit 107 is supplied to the radio unit 108. The radio unit 108 performs processing such as frequency conversion (upconversion) or power amplification to generate a radio frequency (RF) signal. The RF signal from the radio unit 108 is supplied to the antenna 109, and propagated as an electric wave in a space.

The first transmission instruction signal 111 and the second transmission instruction signal 112 are also input into the collision prediction unit 103. The collision prediction unit 103 predicts the collision of the first transmission signal with the second transmission signal based on the first transmission instruction signal 111 and the second transmission instruction signal 112. When the collision prediction unit 103 predicts the collision, a collision prediction signal 113 is supplied to the signal stop unit 104. The second transmission instruction signal 112 is also supplied to the signal stop unit 104.

When the collision prediction signal 113 is received, that is, when the collision of the first transmission signal with the second transmission signal is predicted, the signal stop unit 104 supplies, to the first transmission signal generation unit 105 and the second transmission signal generation unit 106, stop signals 115 and 116 which control the stop operation of the first transmission signal and the second transmission signal.

Specifically, the signal stop unit 104 controls the first transmission signal generation unit 105 and the second transmission signal generation unit 106 based on the stop signals 115 and 116 so that the first transmission signal is sopped while the collision is predicted in a case where the second transmission signal is multiplied by the orthogonal code at a time when the collision is predicted and so that the second transmission signal is stopped while the collision is predicted in a case where the second transmission signal is not multiplied by the orthogonal code. In this case, based on the second transmission instruction signal 112, the signal stop unit 104 is instructed as to whether or not the second transmission signal is multiplied by the orthogonal code.

The transmission of the first and second transmission signals is controlled in this manner, whereby the increase of a PAPR is avoided. Moreover, the large degradation of the performance of the second transmission signal can be avoided, and the continuous stop of the first transmission signal over a long period can be decreased.

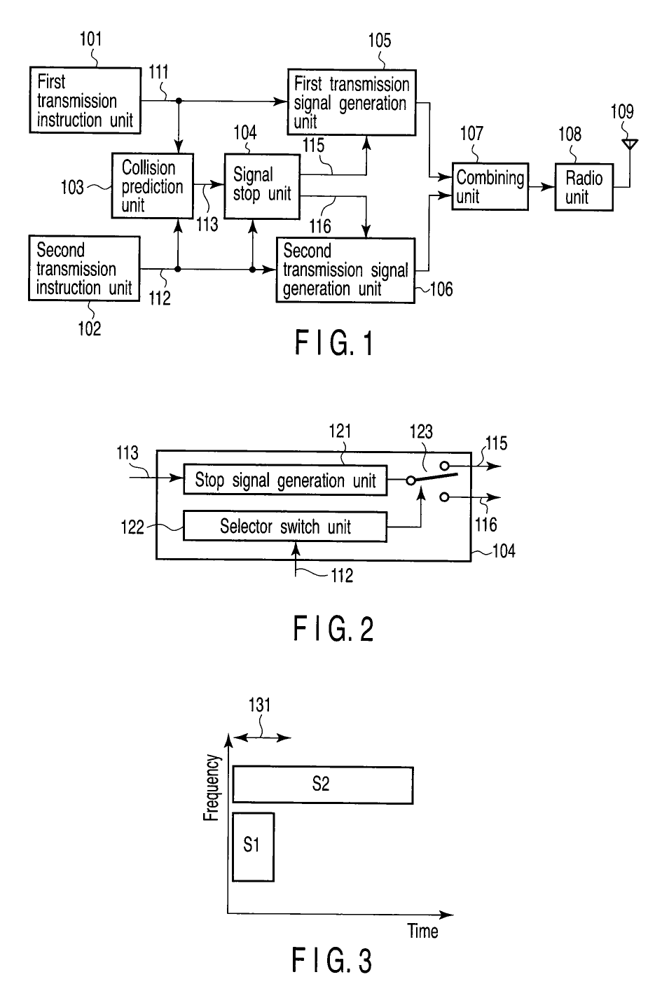

FIG. 2 shows a specific example of the signal stop unit 104 shown in FIG. 1. When the collision prediction signal 113 is input into the signal stop unit 104, a stop signal generation unit 121 generates a stop signal. On the other hand, there is provided a selector switch unit 122, which operates in accordance with the second transmission instruction signal 112, and the selector switch unit 122 controls a selector 123. The selector 123 is provided so that the stop signal output from the stop signal generation unit 121 is received to selectively supply the stop signals 115 and 116 to the first transmission signal generation unit 105 and the second transmission signal generation unit 106.

In a case where the second transmission instruction signal 112 is input and the second transmission instruction signal 112 indicates that the second transmission signal is multiplied by the orthogonal code, during the generation of the collision prediction signal 113 (while the collision is predicted) the selector 123 supplies the stop signal 115 to the first transmission signal generation unit 105 to stop the first transmission signal.

On the other hand, in a case where the second transmission instruction signal 112 is input and the second transmission instruction signal 112 indicates that the second transmission signal is not multiplied by the orthogonal code, while the collision is predicted, the selector 123 supplies the stop signal 116 to the second transmission signal generation unit 106 to stop the second transmission signal.

Next, the operation and effect of the first embodiment will be described in detail with reference to FIGS. 3, 4, 5, 6, 7 and 8.

FIG. 3 shows an example of a time-frequency region in which a first transmission signal S1 and a second transmission signal S2 are allocated. In a case where the first transmission signal S1 and the second transmission signal S2 allocated as shown in FIG. 3 are simultaneously transmitted, the first transmission signal S1 and the second transmission signal S2 are multiplexed in a frequency direction in a period 131. That is, in the period 131, the first transmission signal S1 temporally overlaps with the second transmission signal S2. Therefore, in this case, the signals collide with each other. The signal transmitted in the period 131 becomes a multi carrier signal, and the PAPR is increased.

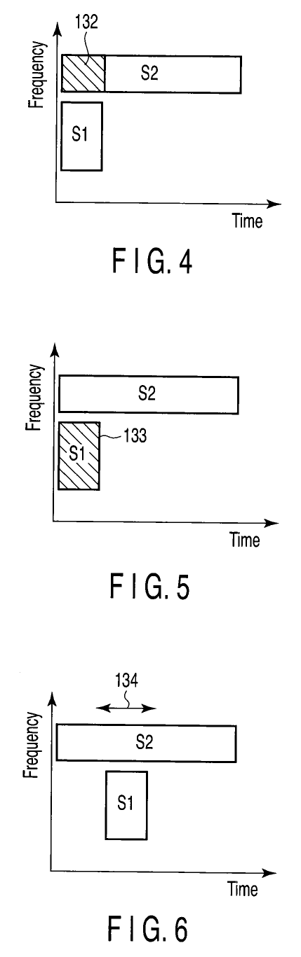

In a case where the collision of the first transmission signal S1 and the second transmission signal S2 is predicted in this manner, one of the second transmission signal S2 (an overlap portion 132) while the collision with the first transmission signal S1 is predicted as shown in FIG. 4, and the first transmission signal S1 (an overlap portion 133) while the collision with the second transmission signal S2 is predicted as shown in FIG. 5 is stopped. In consequence, it can be avoided that the transmitted signal becomes a multi carrier signal, and an increase of the PAPR can be avoided.

However, in the examples shown in FIGS. 4 and 5, the whole first transmission signal S1 overlaps the second transmission signal S2, so that the whole first transmission signal S1 is a target to be stopped. When a part of the first transmission signal S1 overlaps with the second transmission signal S2, only the overlap portion may be stopped.

FIG. 6 shows another example of the time-frequency region in which the first transmission signal S1 and the second transmission signal S2 are allocated. In a case where the first transmission signal S1 and the second transmission signal S2 allocated as shown in FIG. 6 are simultaneously transmitted, the first transmission signal S1 and the second transmission signal S2 are multiplexed in the frequency direction in a period 134 in the same manner as in the period 131 shown in FIG. 3. That is, in the period 134 of FIG. 6, the first transmission signal S1 temporally overlaps the second transmission signal S2 in the same manner as in the period 131.

In FIG. 3, the period 131 is positioned at the top of the transmission period of the second transmission signal S2, whereas in FIG. 6, the period 134 is positioned at the middle of the transmission period of the second transmission signal S2. In FIG. 6, the signal transmitted in the period 134 becomes a multi carrier signal, and the PAPR is increased in the same manner as in FIG. 3.

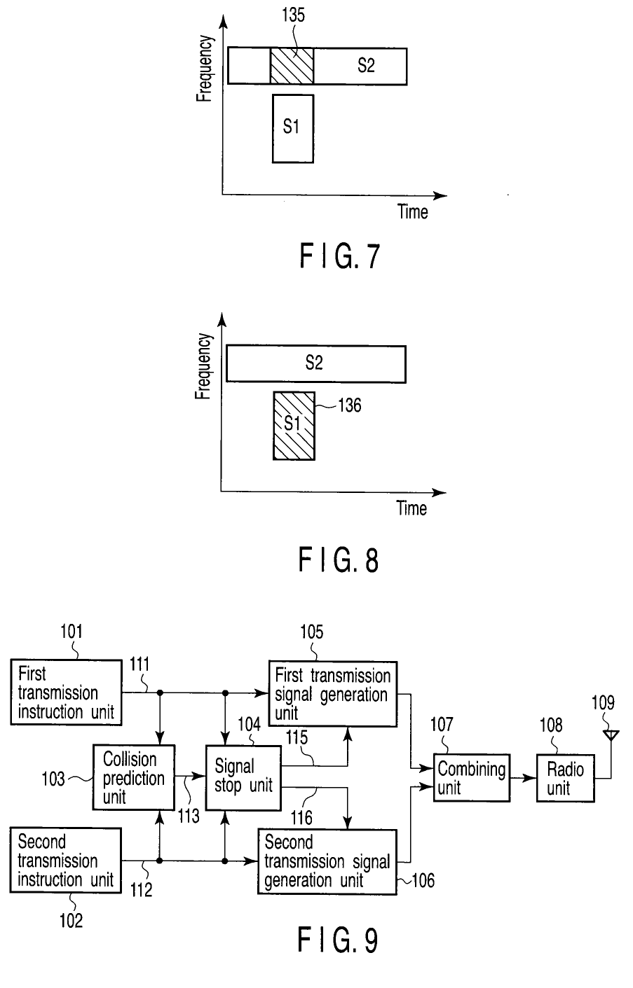

In a case where the collision of the first transmission signal S1 and the second transmission signal S2 is predicted in this manner, one of the second transmission signal S2 (an overlap portion 135) during the collision with the first transmission signal S1 as shown in FIG. 7 and the first transmission signal S1 (an overlap portion 136) during the collision with the second transmission signal S2 as shown in FIG. 8 is stopped. In consequence, it can be avoided that the signal becomes a multi carrier signal, and the increase of the PAPR can be avoided.

However, even in the examples shown in FIGS. 7 and 8, the whole first transmission signal S1 overlaps the second transmission signal S2 in the same manner as in the examples of FIGS. 4 and 5, so that the whole first transmission signal S1 is the target to be stopped. When a part of the first transmission signal S1 overlaps with the second transmission signal S2, only the overlap portion may be stopped.

Next, there will be described a different aspect between the present embodiment and the conventional technology described in R1-073092, “Sounding RS Multiplexing in E-UTRA UL-Interaction with PUCCH”, Samsung. In the conventional technology, a method of stopping a part of the second transmission signal S2 as shown in FIGS. 4 and 7 and a method of stopping the first transmission signal S1 as shown in FIGS. 5 and 8 are disclosed.

In a case where a part of the second transmission signal S2 is stopped as shown in FIGS. 4 and 7, the signal of a part of the second transmission signal S2 is trimmed, whereby a receiving performance deteriorates. In particular, when the second transmission signal S2 is multiplied by the orthogonal code and the signal of the part is trimmed, the orthogonality of the orthogonal code cannot be maintained, and a large performance degradation is sometimes caused.

On the other hand, when the first transmission signal S1 is stopped as shown in FIGS. 5 and 8, the whole first transmission signal S1 is not transmitted. When such a state continues over a long period, an object to be achieved by the first transmission signal S1 is not realized over a long period. The object to be achieved by the first transmission signal S1 will be described later in accordance with a specific example.

To achieve the object, it is decided as a decision standard whether or not the second transmission signal S2 is multiplied by the orthogonal code, and it is determined whether to stop one of the first transmission signal S1 and the second transmission signal S2. As described above, the second instruction signal 112 indicates whether or not the second transmission signal S2 is multiplied by the orthogonal code. That is, when the second transmission signal S2 is multiplied by the orthogonal code and a part of the second transmission signal S2 is stopped, the performance of the second transmission signal S2 largely deteriorates. Therefore, as shown in FIGS. 5 and 8, the first transmission signal S1 is stopped, and the second transmission signal S2 is transmitted. In this case, it can be avoided that the performance of the second transmission signal S2 largely deteriorates.

On the other hand, when the second transmission signal S2 is not multiplied by the orthogonal code, the performance of the second transmission signal S2 does not largely deteriorate. Therefore, as shown in FIGS. 4 and 7, a part of the second transmission signal S2 is stopped, and the first transmission signal S1 is transmitted. In this case, an opportunity to transmit the first transmission signal S1 increases, so that the continuous stop of the first transmission signal S1 over a long period can be decreased.

As described above, in the radio transmitter according to the first embodiment, in a case where the collision of the first and second transmission signals is predicted, when the second transmission signal is multiplied by the orthogonal code, the first transmission signal is stopped or a signal amplitude is decreased during the prediction of the collision. When the second transmission signal is not multiplied by the orthogonal code, the second transmission signal is stopped or a signal amplitude is decreased during the prediction of the collision. In consequence, the increase of the PAPR is avoided. Moreover, one of the first and second transmission signals is stopped, whereby problems can be decreased. That is, the large degradation of the performance of the second transmission signal S2 is avoided, and the continuous stop of the first transmission signal S1 over a long period can be decreased.

### Modification 1 of First Embodiment

FIG. 9 is a diagram showing a modification of the radio transmitter according to the first embodiment. The constitution of a signal stop unit 104 is different from that of the first embodiment. Furthermore, this embodiment is different from FIG. 1 in that in addition to a second transmission instruction signal 112, a first transmission instruction signal 111 is input into the signal stop unit 104.

To avoid the continuous transmission stop of a first transmission signal S1 over a long period, for example, the number of continuous stop times is counted. When this number of times exceeds a certain threshold value, as shown in FIGS. 4 and 7, overlap portions 132 and 135 of a second transmission signal S2 with the first transmission signal S1 may be stopped, regardless of whether or not the second signal is multiplied by an orthogonal code. In consequence, it can be avoided that the first transmission signal S1 is continuously stopped by as much as the number of times above the threshold value.

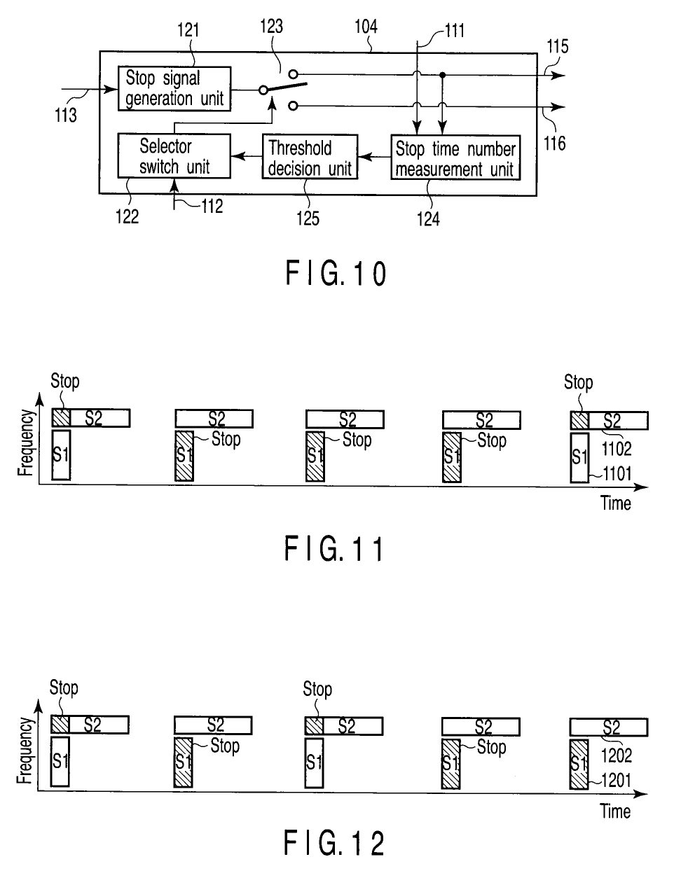

FIG. 10 shows a first specific example of the signal stop unit 104 shown in FIG. 9 based on the above-mentioned idea. A stop signal generation unit 121, a selector switch unit 122 and a selector 123 are similar to those of the signal stop unit 104 shown in FIG. 2, and a stop time number measurement unit 124 and a threshold decision unit 125 are added. The first transmission instruction signal 111 and a stop signal 115 output from the selector switch unit 122 are input into the stop time number measurement unit 124. In the stop time number measurement unit 124, while the first transmission instruction signal 111 is input, the number of times of generation of the stop signal 115, that is, the number of times of the continuous stop of the first transmission signal is measured.

The measurement result of the stop time number measurement unit 124 is input into the threshold decision unit 125, and the threshold decision unit 125 decides whether or not the number of times of the continuous stop of the first transmission signal exceeds a certain threshold value. Here, in a case where it is decided that the number of times when the first transmission signal continuously stops exceeds the certain threshold value and the collision of the first and second transmission signals is predicted, the selector switch unit 122 allows the selector 123 to supply the stop signal 116 to the second transmission signal generation unit 106 to stop the second transmission signal.

An example in which the threshold value for use in the threshold decision unit 125 is set to 2 will hereinafter be described with reference to FIGS. 11, 12 and 13.

When the first transmission signal S1 and the second transmission signal S2 are transmitted as shown in FIG. 11 and the first transmission signal S1 (1101) and the second transmission signal S2 (1102) are transmitted in a time point at the right end of FIG. 11, the first transmission signal S1 has already been stopped continuously three times. Therefore, in this case, the number of the stop times exceeds a threshold value of two, so that a part of the second transmission signal S2 is stopped and the first transmission signal S1 is transmitted regardless of whether or not the second transmission signal 1102 is multiplied by an orthogonal code.

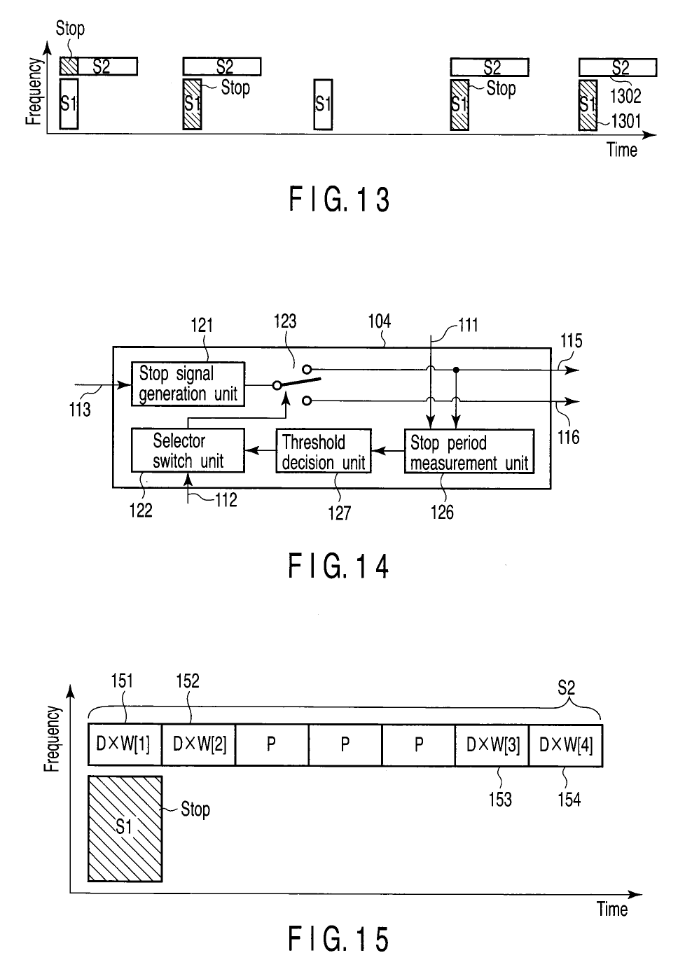

On the other hand, in a case where the first transmission signal S1 is not continuously stopped as shown in FIG. 12, it is determined whether the first transmission signal S1 (1201) or the second transmission signal S2 (1202) is stopped in a time point at the right end of FIG. 12, depending on whether or not the second transmission signal S2 is multiplied by the orthogonal code in the same manner as in the first embodiment. Moreover, as shown in FIG. 13, even when only the first transmission signal S1 (1301) is transmitted and the second transmission signal S2 (1302) is not transmitted in a time point at the right end of FIG. 13, it is decided that there has not been any continuous stop.

In the above description, it is decided whether or not the first transmission signal S1 is prioritized, based on the number of times when the first transmission signal S1 is continuously stopped. In a case where the first transmission signal S1 is periodically transmitted, the number of times when the first transmission signal S1 is continuously stopped indicates a period in which the first transmission signal S1 is not transmitted. In other words, it is regarded as a decision standard that the first transmission signal S1 is prioritized in a case where the first transmission signal S1 is not transmitted for a certain period.

In a case where the first transmission signal S1 is not non-periodically transmitted, the number of times when the signal is continuously stopped does not necessarily indicate the continuous stop for a certain period. Therefore, in a case where the first transmission signal S1 is non-periodically transmitted, instead of using the number of the stop times, the period in which the signal is stopped is measured and stored. When this period exceeds a certain threshold value, the transmission of the first transmission signal S1 may be prioritized. To prioritize the transmission of the first transmission signal S1 indicates that the second transmission signal S2 is stopped and that the first transmission signal S1 is transmitted.

FIG. 14 shows a second specific example of the signal stop unit 104 shown in FIG. 9 based on such an idea. A stop signal generation unit 121, a selector switch unit 122 and a selector 123 are similar to those of the signal stop unit 104 shown in FIG. 2. In FIG. 14, a stop period measurement unit 126 and a threshold decision unit 127 are added. A first transmission instruction signal 111 and a stop signal 115 output from the selector switch unit 122 are input into the stop period measurement unit 126. In the stop period measurement unit 126, a time length of a period in which the stop signal 115 is generated while the first transmission instruction signal 111 is input, that is, the stop period of the first transmission signal is measured.

The measurement result of the stop period measurement unit 126 is input into the threshold decision unit 127, and the threshold decision unit 127 decides whether or not the stop period of the first transmission signal exceeds a certain threshold value. Here, in a case where it is decided that the stop period of the first transmission signal exceeds the certain threshold value, when the collision of the first and second transmission signals is predicted, the selector switch unit 122 allows the selector 123 to supply the stop signal 116 to the second transmission signal generation unit 106, the second transmission signal is stopped.

(Concerning Application to LTE)

Next, an example in which the first embodiment is applied to long term evolution (LTE) investigated as one of higher-speed data communication specifications in the 3GPP will be described. The SRS in the LTE investigated in the 3GPP can be regarded as a first transmission signal, and PUCCH can be regarded as a second transmission signal. The SRS is a signal for use in channel estimation, and is formed of a known signal. The PUCCH is a signal for use in notifying control information to a base station, and the signal is formed of a data signal generated by modulating the control information, and the known signal for use in channel estimation for demodulating this data signal. It is also investigated that the PUCCH and the SRS are arranged at different places in a frequency direction. Moreover, both the PUCCH and the SRS are single carrier signals.

Processing such as uplink scheduling, transmission power control or timing control is performed based on the channel estimation result obtained by the SRS. When the precision of the channel estimation deteriorates, the precision of such processing deteriorates. In general, the channel temporally gradually changes. Therefore, even when the SRS is not transmitted for a short period, the present channel can be estimated with a certain degree of precision based on past information. However, if the SRS is stopped over a long period, the precision of the channel estimation cannot be maintained. When a method of stopping only the SRS as described in the conventional technology is employed, there is a high possibility that the SRS is continuously stopped over a long period. As a result, the performance of processing such as the uplink scheduling, transmission power control or timing control might largely deteriorate.

On the other hand, in a case where a part of the signal of the PUCCH is stopped, when the signal transmitted through the PUCCH is subjected to appropriate channel encoding, the degradation of a receiving performance corresponding to a signal power lost by stopping is usually caused. The PUCCH is sometimes multiplied by an orthogonal code for a purpose of multiplexing a plurality of users. The signal is multiplied by a different orthogonal code for each user, whereby the plurality of users can be multiplexed in the same time-frequency region.

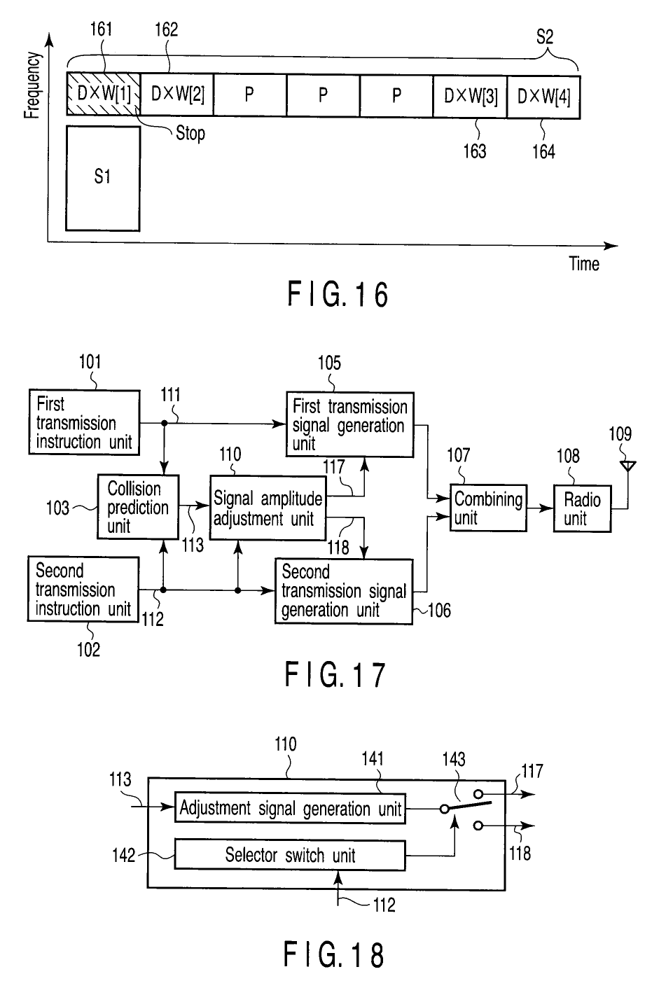

When the orthogonality of the orthogonal code is completely maintained, any interference among the users is not generated. Therefore, the base station can separate and obtain the signal of the PUCCH from each user by use of the orthogonal code for use in each user. However, when a part of the PUCCH signal is stopped, a part of the orthogonal code is lost, whereby the orthogonality cannot be maintained. This will be described with reference to FIGS. 15 and 16.

The example of FIG. 15 shows an example in which when the first transmission signal collides with the second transmission signal, the first transmission signal S1 is stopped. Moreover, FIG. 15 shows an example in which a transmission signal D obtained by modulating information to be transmitted is multiplied by an orthogonal code W={W[1], W[2], W[3], W[4]} having a serial length of 4. In FIG. 15, P indicates a known signal. The transmission signal of User 1 and the orthogonal code to be multiplied by this signal are set to D1 and W1, and the transmission signal of User 2 and the orthogonal code to be multiplied by this signal are set to D2 and W2. However, W1 and W2 are codes crossing each other at right angles. At this time, the transmission signal of User 1 to be transmitted from symbols 151, 152, 153 and 154 is represented as follows.

D1×W1[1]

D1×W1[2] (1)

D1×W1[3]

D1×W1[4]

Similarly, the transmission signal of User 2 to be transmitted from the symbols 151, 152, 153 and 154 is represented as follows.

D2×W2[1]

D2×W2[2] (2)

D2×W2[3]

D2×W2[4]

In the base station, these transmission signals of Users 1 and 2 are multiplexed and received, so that in the base station, the signals to be received by the symbols 151, 152, 153 and 154 are represented as follows.

R[1]=D1×W1[1]+D2×W2[1]

R[2]=D1×W1[2]+D2×W2[2] (3)

R[3]=D1×W1[3]+D2×W2[3]

R[4]=D1×W1[4]+D2×W2[4]

To take D1 from the received signal R, R may be multiplied by W1 and added up. That is, the following equation may be calculated.

$$R [ 1 ] \times W 1 [ 1 ] + R [ 2 ] \times W 1 [ 2 ] + R [ 3 ] \times W 1 [ 3 ] + R [ 4 ] \times W 1 [ 4 ] = D 1 \times ( W 1 [ 1 ] 2 + W 1 [ 2 ] 2 + W 1 [ 3 ] 2 + W 1 [ 4 ] 2 ) + D 2 \times ( W 1 [ 1 ] \times W 2 [ 1 ] + W 1 [ 2 ] \times W 2 [ 2 ] + W 1 [ 3 ] \times W 2 [ 3 ] + W 1 [ 4 ] \times W 2 [ 4 ] ) = D 1 \times ( W 1 [ 1 ] 2 + W 1 [ 2 ] 2 + W 1 [ 3 ] 2 + W 1 [ 4 ] 2 ) \qquad ( 4 )$$

It is seen that owing to the orthogonality of W1 and W2, D2 components disappear and only the signal D1 from User 1 can be taken.

Next, there will be described an influence in a case where symbol 161 of the second transmission signal S2 predicted to collide with the first transmission signal S1 is stopped in User 2 as shown in FIG. 16. In this case, the transmission signal of User 1 is represented as follows.

D1×W1[1]

D1×W1[2] (5)

D1×W1[3]

D1×W1[4]

Similarly, the transmission signal of User 2 is represented as follows.

0

D2×W2[2] (6)

D2×W2[3]

D2×W2[4]

In the base station, these transmission signals of Users 1 and 2 are multiplexed and received, so that signals received in symbols 161, 162, 163 and 164 are represented as follows.

R[1]=D1×W1[1]+0

R[2]=D1×W1[2]+D2×W2[2]

R[3]=D1×W1[3]+D2×W2[3] (7)

R[4]=D1×W1[4]+D2×W2[4]

In the same manner as described above, calculation in which the received signals R are multiplied by W1 and added up is performed as follows.

$$R [ 1 ] \times W 1 [ 1 ] + R [ 2 ] \times W 1 [ 2 ] + R [ 3 ] \times W 1 [ 3 ] + R [ 4 ] \times W 1 [ 4 ] = D 1 \times ( W 1 [ 1 ] 2 + W 1 [ 2 ] 2 + W 1 [ 3 ] 2 + W 1 [ 4 ] 2 ) + D 2 \times ( W 1 [ 2 ] \times W 2 [ 2 ] + W 1 [ 3 ] \times W 2 [ 3 ] + W 1 [ 4 ] \times W 2 [ 4 ] ) \qquad ( 8 )$$

Thus, a part of the orthogonal code is not transmitted, and the orthogonality of the transmission signal of User 1 and the transmission signal of User 2 collapses, whereby the transmission signal D2 of User 2 cannot be eliminated. As a result, D2 remains as interference, so that the receiving performance of the transmission signal D1 of User 1 largely deteriorates.

According to the first embodiment of the present invention, it is decided whether or not the PUCCH as the second transmission signal S2 is multiplied by the orthogonal code, and it is determined using this decision standard whether the SRS as the first transmission signal S1 or the PUCCH as the second transmission signal S2 is stopped. For example, as shown in FIG. 15, when the PUCCH as the second transmission signal S2 is multiplied by the orthogonal code, the SRS as the first transmission signal S1 is stopped, and the PUCCH as the second transmission signal is transmitted. In consequence, the large degradation of the performance of the PUCCH due to the absence of a part of the orthogonal code multiplied by the PUCCH can be prevented.

Moreover, when the PUCCH is not multiplied by the orthogonal code, a part of the signal of the PUCCH is stopped, and the SRS can be transmitted. In consequence, it can be prevented that the SRS is continuously stopped over a long period.

### Second Embodiment

As shown in FIG. 17, a radio transmitter according to a second embodiment of the present invention includes a first transmission instruction unit 101, a second transmission instruction unit 102, a collision prediction unit 103, a signal amplitude adjustment unit 110, a first transmission signal generation unit 105, a second transmission signal generation unit 106, a combining unit 107, a radio unit 108 and an antennal 109. That is, the present embodiment is different from the radio transmitter according to the first embodiment in that the signal stop unit 104 shown in FIG. 1 is replaced with the signal amplitude adjustment unit 110.

When a collision prediction signal 113 is received from the collision prediction unit 103, that is, when the collision of a first transmission signal with a second transmission signal is predicted, the signal amplitude adjustment unit 110 supplies, to the first transmission signal generation unit 105 and the second transmission signal generation unit 106, amplitude control signals 117 and 118 for decreasing the amplitude of the first and second transmission signals. Specifically, the first transmission signal generation unit 105 and the second transmission signal generation unit 106 are controlled based on the amplitude control signals 117 and 118 so that when the collision is predicted and the second transmission signal is multiplied by an orthogonal code, the amplitude of the first transmission signal is decreased while the collision is predicted. When the second transmission signal is not multiplied by the orthogonal code, the amplitude of the second transmission signal is decreased while the collision is predicted.

In the first embodiment, when the collision is predicted, a part or all of the transmission signals is stopped. On the other hand, the present embodiment is different from the first embodiment in that when the collision is predicted, the amplitude of a part or all of the transmission signals is decreased. In a case where two single carrier signals are multiplexed in a frequency direction, a PAPR increases as compared with a case where signals are individually transmitted. However, when there is a large difference between signal powers of the two single carrier signals, the PAPR of the multiplexed signal has a value approximately equal to that of the PAPR of the signal having a larger signal power.

Thus, the signal power of one of the signals to be multiplexed is lowered, that is, the signal amplitude is decreased, whereby the increase of the PAPR can be avoided. Furthermore, unlike the first embodiment, instead of stopping the transmission signal, the transmission is continued with a smaller power, so that the problem of the conventional technology can further efficiently be avoided. Specifically, the large degradation of the performance of the second transmission signal can be avoided. Moreover, average characteristics can be improved, and the continuous stop of the first transmission signal over a long period can be avoided.

FIG. 18 shows a specific example of the signal amplitude adjustment unit 110 shown in FIG. 17. When the collision prediction signal 113 is input into the signal amplitude adjustment unit 110, an adjustment signal generation unit 141 generates an amplitude adjustment signal. On the other hand, there is provided a selector switch unit 142 which operates in accordance with a second transmission instruction signal 112, and the selector switch unit 142 controls a selector 143. The selector 143 is provided so that the amplitude adjustment signal output from the adjustment signal generation unit 141 is selectively supplied to the first transmission signal generation unit 105 and the second signal combining unit 106.

In a case where the second transmission instruction signal 112 is input and the second transmission instruction signal 112 indicates that the second transmission signal is multiplied by the orthogonal code, while the collision prediction signal 113 is generated (while the collision is predicted), the selector 143 supplies the amplitude adjustment signal 117 to the first transmission signal generation unit 105, whereby the amplitude of the first transmission signal is decreased. On the other hand, in a case where the second transmission instruction signal 112 is input and the second transmission instruction signal 112 indicates that the second transmission signal is not multiplied by the orthogonal code, while the collision is predicted, the selector 143 supplies the amplitude adjustment signal 118 to the second transmission signal generation 106, whereby the amplitude of the second transmission signal is decreased.

### Modification of Second Embodiment

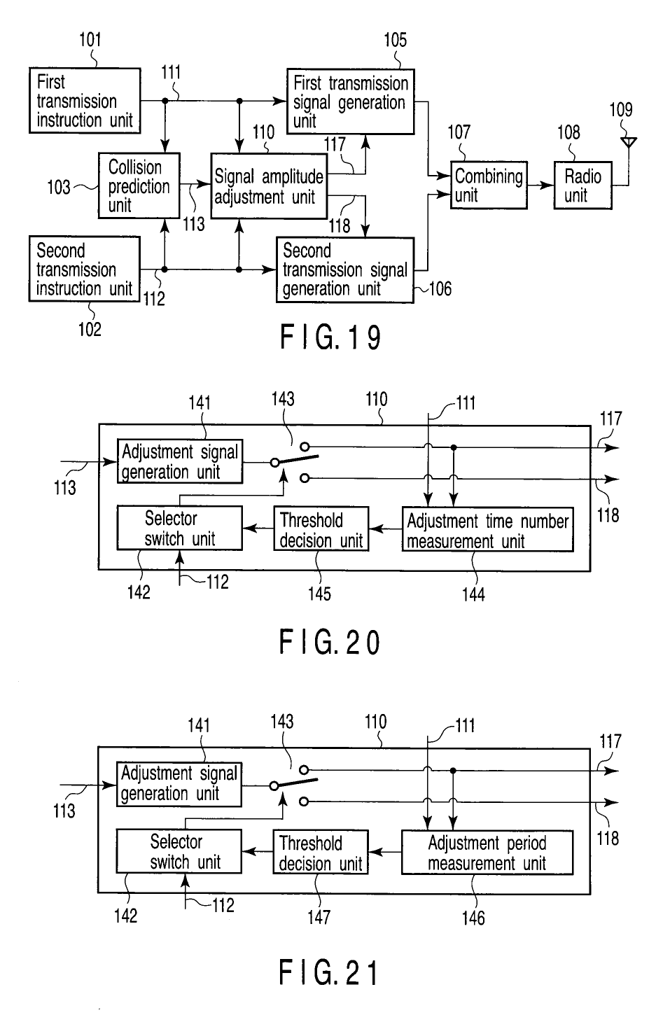

FIG. 19 shows a radio transmitter according to a modification of the second embodiment. This is different from FIG. 12 in that in addition to a second transmission instruction signal 112, a first transmission instruction signal 111 is input into a signal amplitude adjustment unit 110.

Next, the operation and effect of the second embodiment will be described in detail with reference to FIGS. 11, 12 and 13. In the first embodiment, in a case where the first transmission signal S1 and the second transmission signal S2 are allocated as shown in FIGS. 3 and 6, it is determined whether the overlap portion of the second transmission signal S2 with the first transmission signal S1 shown in FIGS. 4 and 7 or the overlap portion of the first transmission signal S1 with the second transmission signal S2 shown in FIGS. 5 and 8 is stopped, depending on a decision standard that the second transmission signal S2 is multiplied by the orthogonal code.

On the other hand, in the second embodiment, instead of stopping the transmission signals of the overlap portions 132, 133, 135 and 136 shown in FIGS. 4, 5, 7 and 8, the amplitudes of these transmission signals are decreased. Here, the decrease in the amplitude is realized, for example, by multiplying the transmission signal of the amplitude adjustment target of the overlap portion by a value X smaller than 1. In this case, as the value X decreases, the PAPR can be decreased. On the other hand, the performance of the processing using the first transmission signal S1 and the second transmission signal S2 is deteriorated, so that it is preferable to determine the value X in consideration of the above problem.

Specifically, for example, to prioritize the PAPR, X is set to a small value. When the performances of the first transmission signal S1 and the second transmission signal S2 are prioritized, X may be set to a value close to 1.

Moreover, in consideration of the priorities of the first transmission signal S1 and the second transmission signal S2, the value of X for use in the first transmission signal S1 may be different from that of X for use in the second transmission signal S2. For example, in a case where the value of X to be multiplied by the first transmission signal S1 is set to X1 and the value of X to be multiplied by the second transmission signal S2 is set to X2, when the first transmission signal S1 has a higher priority, the values are set so that X1>X2. When the second transmission signal S2 has a higher priority, the values are set so that X1<X2. When the priority of the first transmission signal S1 is approximately the same as that of the second transmission signal S2, X1=X2 is set.

Furthermore, X1 and X2 may be determined based on a power ratio or difference between the first transmission signal S1 and the second transmission signal S2. For example, when the power of the first transmission signal S1 is P1 and the power of the second transmission signal S2 is P2, X1 is set to a value proportional to P2/P1 or a logarithmic value, and X2 is set to a value proportional to P1/P2 or a logarithmic value.

Moreover, for example, when the signal power of the first transmission signal S1 before amplitude adjustment is sufficiently smaller than that of the second transmission signal S2, the value for use in the amplitude adjustment of the first transmission signal S1 may be set to a value close to 1. Conversely, when the signal power of the first transmission signal S1 before the amplitude adjustment is sufficiently larger than that of the second transmission signal S2, the value for use in the amplitude adjustment of the first transmission signal S1 may be set to a value close to 0. These matters also apply to a case where the amplitude of the second transmission signal S2 is adjusted.

Furthermore, the value of X may be varied with time. For example, when the amplitude of the first transmission signal S1 is decreased at two predetermined time points and a time interval between the two time points is short, the value for use in the second time may be larger than that for use in the first time. As shown in FIGS. 3 to 8, in an example in which the whole amplitude of the first transmission signal S1 is adjusted and the amplitude of only a part of the second transmission signal S2 is adjusted, for example, the value X1 to be multiplied by the first transmission signal S1 may be set to a value larger than 0, and the value X2 to be multiplied by the second transmission signal S2 may be set to 0. This is because the amplitude of only a part of the second transmission signal S2 is adjusted. Even when the signal is multiplied by 0 to obtain a signal amplitude of 0, the second transmission signal S2 can be demodulated to a certain degree owing to the remaining signal whose amplitude is not adjusted.

Next, the effect of the second embodiment will be described. As described above, the signal amplitude of one of two transmission signals to be multiplexed is decreased, whereby the PAPR can be decreased. That is, the PAPR can be decreased even in the second embodiment in the same manner as in the first embodiment. In the second embodiment, in addition to this effect, performances concerning the first transmission signal and the second transmission signal can be improved as follows.

The first transmission signal is not stopped in the second embodiment, so that the continuous stop over a long period can be avoided. That is, instead of stopping the overlap portion of the second transmission signal, the signal amplitude is decreased. Therefore, as compared with the first embodiment, the transmission power of the whole second transmission signal is large. The receiving performance is easily improved as compared with the first embodiment. As a result, average characteristics can easily be improved.

In the first embodiment, the method of avoiding the stopping of the first transmission signal over a long period has been described, and a method of avoiding the amplitude decrease of the first transmission signal over a long period as in the second embodiment is basically similar to the above method. That is, the number of times when the amplitude of the first transmission signal is continuously decreased is measured and stored, and the transmission of the first transmission signal may be prioritized in a case where this number of times exceeds a threshold value.

FIG. 20 shows a first specific example of the signal amplitude adjustment unit 110 shown in FIG. 19 based on such an idea. An adjustment signal generation unit 141, a selector switch unit 142 and a selector 143 are similar to those of the signal amplitude adjustment unit 110 shown in FIG. 18.

In FIG. 20, an adjustment time number measurement unit 144 and a threshold decision unit 145 are added. A first transmission instruction signal 111 and an amplitude adjustment signal 117 output from the selector 143 are input into the adjustment time number measurement unit 144. In the adjustment time number measurement unit 144, while the first transmission instruction signal 111 is input, the number of times when the amplitude adjustment signal 117 is generated, that is, the number of times when the amplitude of the first transmission signal is continuously decreased is measured.

The measurement result of the adjustment time number measurement unit 144 is input into the threshold decision unit 145, and the threshold decision unit 145 decides whether or not the number of times when the amplitude of the first transmission signal is continuously decreased exceeds a certain threshold value. Here, in a case where it is decided that the number of times when the amplitude of the first transmission signal is continuously decreased exceeds the certain threshold value and the collision of the first and second transmission signals is predicted, the selector switch unit 142 allows the selector 143 to supply an amplitude adjustment signal 118 to the second transmission signal generation unit 106, whereby the amplitude of the second transmission signal is decreased.

In a case where the number of times when the amplitude of the first transmission signal is continuously decreased exceeds the threshold value, instead of prioritizing the transmission of the first transmission signal, a period in which the amplitude of the first transmission signal is continuously decreased is measured and stored. In a case where this period exceeds the threshold value, even when the transmission of the first transmission signal is prioritized, a similar effect is obtained.

FIG. 21 shows a second specific example of the signal amplitude adjustment unit 110 in FIG. 19 based on such an idea. An adjustment signal generation unit 141, a selector switch unit 142 and a selector 143 are similar to those of the signal amplitude adjustment unit 110 shown in FIG. 20.

In FIG. 21, an adjustment period measurement unit 146 and a threshold decision unit 147 are added. A first transmission instruction signal 111 and an amplitude adjustment signal 117 output from the selector 143 are input into the adjustment period measurement unit 146. In the adjustment period measurement unit 146, a time length of a period in which the amplitude adjustment signal 117 is generated while the first transmission instruction signal 111 is input, that is, the amplitude adjustment period of the first transmission signal is measured.

The measurement result of the adjustment period measurement unit 146 is input into the threshold decision unit 147, and the threshold decision unit 147 decides whether or not the amplitude adjustment period (a period in which the amplitude is continuously decreased) of the first transmission signal exceeds a certain threshold value. Here, in a case where the amplitude adjustment period of the first transmission signal exceeds the certain threshold value, when the collision of the first transmission signal with the second transmission signal is predicted, the selector switch unit 142 allows the selector 143 to supply a stop signal 116 to the second transmission signal generation unit 106, whereby the amplitude adjustment of the second transmission signal is stopped.

(Concerning Application to LTE)

When the second embodiment is applied to LTE, a part of the transmission signal is stopped in the first embodiment, whereas the amplitude of a part of the transmission signal is decreased in the second embodiment. That is, with regard to the transmission signal of the part to be stopped in FIGS. 15 and 16, instead of stopping the transmission signal, the signal amplitude is decreased. When the signal amplitude is decreased instead of stopping the transmission signal, a certain degree of signal power is secured, whereby the receiving performance of the PUCCH and the precision of the channel estimation using the SRS can be improved.

As described above, when the signal transmitted through the PUCCH is subjected to appropriate channel encoding, the degradation of the receiving performance corresponding to the lost signal power is usually caused. Therefore, in a case where the signal amplitude of the transmission signal is decreased to transmit the signal, receiving characteristics can be improved as compared with a case where the transmission signal is stopped.

When the transmission of the SRS is stopped, no information on the channel at that time is obtained, so that the channel at that time is estimated from the past channel estimation result. When the channel does not remarkably fluctuate with time, a certain degree of estimation precision can be maintained. However, when the channel largely fluctuates with time, the estimation precision might noticeably deteriorate. When the signal amplitude of the SRS is decreased to transmit the signal, the signal to noise and interference ratio (SINR) of the SRS deteriorates. Therefore, the channel estimation precision deteriorates as compared with a case where the signal is transmitted with an original signal amplitude. However, as compared with a case where the SRS is stopped, a certain degree of information on the channel at that time is obtained. Therefore, it is possible to follow the fluctuation of the channel by use of this information. In consequence, the channel estimation precision can be improved as compared with a case where the SRS is stopped.

### Selective Use of First Embodiment and Second Embodiment

As described above, as compared with the first embodiment, the second embodiment has advantages that the continuous stop of the first transmission signal over a long period can be avoided and that the average characteristics of the second transmission signal are easily improved. On the other hand, the first embodiment is characterized in that the PAPR is easily decreased. Therefore, it is preferable that the first embodiment is used for prioritizing the characteristics of the PAPR and that the second embodiment is used for prioritizing the performance concerning the first transmission signal S1 and the second transmission signal S2.

According to the first embodiment, the possibility that the continuous transmission stop of the first transmission signal over a long period might occur can be decreased. In other words, the continuous transmission stop of the first transmission signal over a long period can be decreased, but cannot completely be eliminated. On the other hand, according to the second embodiment, the degradation of the precision of the first transmission signal corresponding to the decrease of the signal amplitude occurs, but the continuous transmission stop of the first transmission signal over a long period can be avoided. The first and second embodiments have good and bad points in this manner, so that it is preferable to selectively use the embodiments in accordance with required specifications or the like.

Next, a radio receiver corresponding to the radio transmitter according to the first and second embodiments will be described.

### Third Embodiment

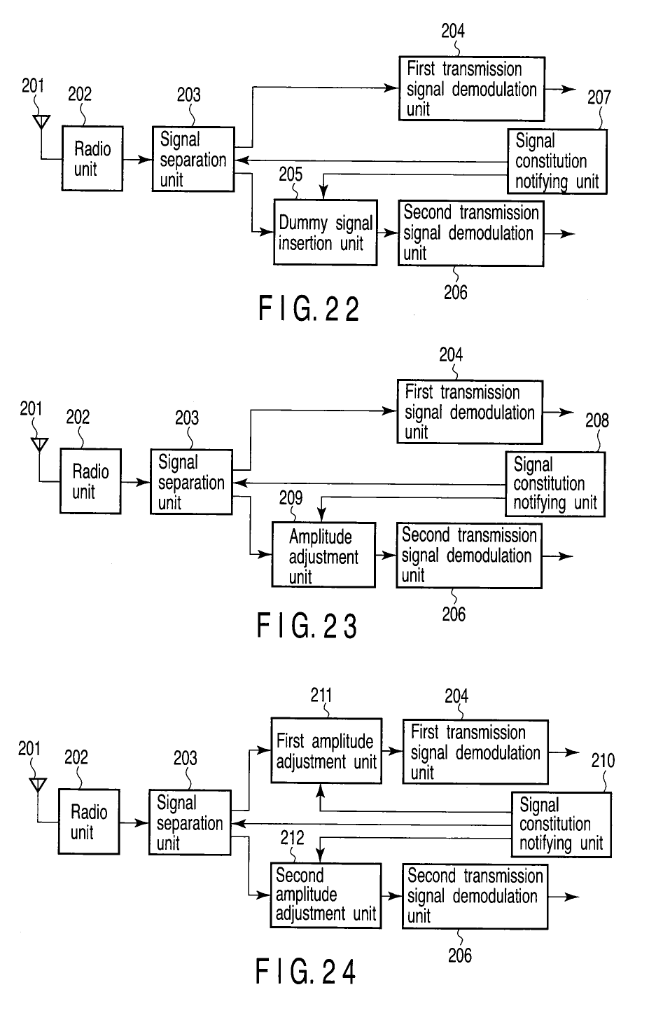

FIG. 22 shows a radio receiver according to a third embodiment of the present invention. The radio receiver is configured to receive a signal to be transmitted from the radio transmitter according to the first embodiment, and includes an antenna 201, a radio unit 202, a signal separation unit 203, a first transmission signal demodulation unit 204, a dummy signal insertion unit 205, a second transmission signal demodulation unit 206 and a signal constitution notifying unit 207.

The antenna 201 receives an RF signal to be transmitted from the radio transmitter according to the first embodiment shown in FIG. 1 or 9. An output signal from the antenna 201 is subjected to processing such as voltage amplification or frequency conversion (downconversion) to generate a base-band received signal.

The received signal output from the radio unit 202 is input into the signal separation unit 203. The signal separation unit 203 recognizes the periods of a first transmission signal and a second transmission signal in the received signal based on a signal constitution notified from the signal constitution notifying unit 207 to separate the received signal into the first transmission signal and the second transmission signal. The first transmission signal from the signal separation unit 203 is input into the first transmission signal demodulation unit 204, and demodulated. On the other hand, the second transmission signal from the signal separation unit 203 is input into the second transmission signal demodulation unit 206 via the dummy signal insertion unit 205.

The dummy signal insertion unit 205 recognizes a period in which the amplitude of the second transmission signal is decreased and a period in which the amplitude of the second transmission signal is not decreased based on the signal constitution notified from the signal constitution notifying unit 207. The unit inserts a dummy signal into the stop period of the second transmission signal from the signal separation unit 203 to output the signal during the stop period of the second transmission signal, and outputs the second transmission signal as it is from the signal separation unit 203 during the non-stop period of the second transmission signal. In consequence, the second transmission signal or the dummy signal output from the dummy signal insertion unit 205 is demodulated by the second transmission signal demodulation unit 206.

More specifically, the signal constitution notifying unit 207 notifies the signal separation unit 203 and the dummy signal insertion unit 205 of the signal constitutions of the first transmission signal and the second transmission signal as described above. Here, the signal constitution basically includes a time-frequency region where the first and second transmission signals are transmitted and a signal format, and is predetermined for transmission and reception. Furthermore, the signal constitution indicates that one of the first and second transmission signals is stopped based on whether or not the second transmission signal is multiplied by an orthogonal code in a case where the collision of the first transmission signal with the second transmission signal is predicted (i.e., a case where there is an overlap portion as described above).

On receiving the notification of such a signal constitution, the signal separation unit 203 separates the received signal from the radio unit 202 into the first transmission signal and the second transmission signal to output the signal. However, in a case where it is notified that the first transmission signal is stopped, the first transmission signal is not separated. The separated first transmission signal from the signal separation unit 203 is input into the first transmission signal demodulation unit 204, and demodulated. The first transmission signal formed of only a known signal is used in channel estimation.

On the other hand, the second transmission signal separated by the signal separation unit 203 is input into the dummy signal insertion unit 205. In a case where it is notified that a part of the second transmission signal has been stopped, the dummy signal having the corresponding length is inserted. The dummy signal may be, for example, a signal all formed entirely of 0s. The signal (the second transmission signal or the dummy signal) to be output from the dummy signal insertion unit 205 is input into the second transmission signal demodulation unit 206, and demodulated.

Thus, according to the third embodiment, even when the first transmission signal or the second transmission signal is selectively stopped, both the transmission signals can be received.

### Fourth Embodiment

FIG. 23 shows a radio receiver according to a fourth embodiment of the present invention. The radio receiver is configured to receive a signal to be transmitted from the radio transmitter according to the second embodiment, and includes an antenna 201, a radio unit 202, a signal separation unit 203, a first transmission signal demodulation unit 204, an amplitude adjustment unit 209, a second transmission signal demodulation unit 206 and a signal constitution notifying unit 208. That is, the present embodiment is different from the radio transmitter according to the third embodiment in that the dummy signal insertion unit 205 shown in FIG. 22 is replaced with the amplitude adjustment unit 209.

A different aspect from the third embodiment will hereinafter be described. A second transmission signal from the signal separation unit 203 is input into the amplitude adjustment unit 209. In the amplitude adjustment unit 209, in a case where it is notified from the signal constitution notifying unit 208 that the amplitude of the second transmission signal has been decreased, this amplitude is corrected to restore an original amplitude. Specifically, for example, when a part of the second transmission signal is multiplied by X on a transmitter side, the amplitude adjustment unit 209 multiplies this portion by an inverse number. In consequence, the amplitude is corrected. The signal having the amplitude corrected is input into the second transmission signal demodulation unit 206 and is demodulated. In consequence, even when the amplitude of one of the first and second transmission signals is selectively decreased, both the signals can be received.

### Modification of Fourth Embodiment

FIG. 24 shows a modification of the radio receiver according to the third embodiment. A first transmission signal separated by a signal separation unit 203 is input into a first transmission signal demodulation unit 204 via a first amplitude adjustment unit 211, and a second transmission signal is input into a second transmission signal demodulation unit 206 via a second amplitude adjustment unit 212 corresponding to the amplitude adjustment unit 209 in FIG. 23. That is, in the radio receiver shown in FIG. 24, the first amplitude adjustment unit 211 is added to the radio receiver shown in FIG. 23.

In an example in which the first and second transmission signals are allocated as shown in FIG. 5 or 8, the whole first transmission signal overlaps with the second transmission signal. Therefore, when the amplitude of the first transmission signal is decreased, the amplitude of the whole signal is decreased. In such a case, the demodulation can be performed without adjusting the amplitude of the first transmission signal as in the radio receiver shown in FIG. 23.

However, when a part of the first transmission signal temporally overlaps with the second transmission signal, only the amplitude of the part of the first transmission signal is decreased. In such a case, the amplitude of the corresponding portion of the radio receiver needs to be corrected. An amplitude correction method is similar to the method performed on the second transmission signal. When a part of the first transmission signal is multiplied by X in the radio transmitter, this part may be multiplied by the inverse number of X in the radio receiver. Even when the amplitude of the whole first transmission signal is decreased, the amplitude may be adjusted in the first amplitude adjustment unit. In this case, the whole first transmission signal is multiplied by the inverse number of X. In consequence, even when the amplitude of a part of the first transmission signal is decreased, the first transmission signal can be demodulated.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio transmitter comprising:
a first instruction unit which generates a first instruction signal to instruct the transmission of a first transmission signal;
a first generation unit which generates the first transmission signal based on the first instruction signal;
a second instruction unit which generates a second instruction signal to instruct the transmission of a second transmission signal to be selectively multiplied by an orthogonal code;
a second generation unit which generates the second transmission signal based on the second instruction signal;
a transmission unit which transmits the first transmission signal and the second transmission signal;
a collision prediction unit which predicts the collision of the first transmission signal with the second transmission signal based on the first instruction signal and the second instruction signal; and
a signal stop unit which stops the first transmission signal while the collision is predicted in a case where the second transmission signal is multiplied by the orthogonal code and which stops the second transmission signal while the collision is predicted in a case where the second transmission signal is not multiplied by the orthogonal code.

2. The radio transmitter according to claim 1, wherein the signal stop unit includes a measurement unit which measures the number of times when the first transmission signal is continuously stopped, and
a decision unit which decides whether or not the number of times exceeds a threshold value, and
the signal stop unit stops the second transmission signal while the collision is predicted regardless of whether or not the second transmission signal is multiplied by the orthogonal code in a case where the number of times exceeds the threshold value.

3. The radio transmitter according to claim 1, wherein the signal stop unit includes a measurement unit which measures the stop period of the first transmission signal, and
a decision unit which decides the stop period exceeds a threshold value, and
the signal stop unit stops the second transmission signal while the collision is predicted regardless of whether or not the second transmission signal is multiplied by the orthogonal code in a case where the stop period exceeds the threshold value.

4. The radio transmitter according to claim 1, wherein the first transmission signal has a frequency band different from that of the second transmission signal.

5. The radio transmitter according to claim 1, wherein the first transmission signal and the second transmission signal are single carrier signals.

6. The radio transmitter according to claim 1, wherein the first transmission signal is a known signal, and the second transmission signal includes a known signal and a data signal.

7. The radio transmitter according to claim 1, wherein the first transmission signal is a sounding reference signal (SRS), and the second transmission signal is a physical uplink control channel (PUCCH).

8. A radio transmitter comprising:
a first instruction unit which generates a first instruction signal to instruct the transmission of a first transmission signal;
a first generation unit which generates the first transmission signal based on the first instruction signal;
a second instruction unit which generates a second instruction signal to instruct the transmission of a second transmission signal to be selectively multiplied by an orthogonal code;
a second generation unit which generates the second transmission signal based on the second instruction signal;
a transmission unit which transmits the first transmission signal and the second transmission signal;
a prediction unit which predicts the collision of the first transmission signal with the second transmission signal based on the first instruction signal and the second instruction signal; and
an adjustment unit which decreases the amplitude of the first transmission signal while the collision is predicted in a case where the second transmission signal is multiplied by the orthogonal code and which decreases the amplitude of the second transmission signal while the collision is predicted in a case where the second transmission signal is not multiplied by the orthogonal code.

9. The radio transmitter according to claim 8, wherein the adjustment unit includes a measurement unit which measures the number of times when the amplitude of the first transmission signal is continuously decreased, and
a decision unit which decides whether or not the number of times exceeds a threshold value, and
the adjustment unit decreases the amplitude of the second transmission signal while the collision is predicted regardless of whether or not the second transmission signal is multiplied by the orthogonal code in a case where the number of times exceeds the threshold value.

10. The radio transmitter according to claim 8, wherein the adjustment unit includes a measurement unit to measure a period in which the amplitude of the first transmission signal is continuously decreased, and
a decision unit which decides whether or not the period exceeds a threshold value, and
the adjustment unit decreases the amplitude of the second transmission signal while the collision is predicted regardless of whether or not the second transmission signal is multiplied by the orthogonal code in a case where the period exceeds the threshold value.

11. The radio transmitter according to claim 8, wherein the first transmission signal has a frequency band different from that of the second transmission signal.

12. The radio transmitter according to claim 8, wherein the first transmission signal and the second transmission signal are single carrier signals.

13. The radio transmitter according to claim 8, wherein the first transmission signal is a known signal, and the second transmission signal includes a known signal and a data signal.

14. The radio transmitter according to claim 8, wherein the first transmission signal is a sounding reference signal (SRS), and the second transmission signal is a physical uplink control channel (PUCCH).

15. A radio receiver comprising:
a reception unit which receives a signal transmitted from the radio transmitter according to claim 1 to obtain a received signal;
a separation unit which separates the received signal into a first transmission signal and a second transmission signal;
a first demodulation unit which demodulates the separated first transmission signal;
a insertion unit which inserts a dummy signal into the stop period of the separated second transmission signal during the stop period of the second transmission signal to output the signal and which outputs the separated second transmission signal during the non-stop period of the second transmission signal; and
a second demodulation unit which demodulates the second transmission signal or the dummy signal output from the dummy signal insertion unit.

16. The radio receiver according to claim 15, further comprising:
a notifying unit which notifies the signal separation unit and the amplitude correction unit of the signal constitutions of the first transmission signal and the second transmission signal,
wherein the separation unit is configured to recognize the periods of the first transmission signal and the second transmission signal in the received signal based on the signal constitutions, and
the insertion unit is configured to recognize the stop period and the non-stop period of the second transmission signal based on the signal constitutions.

17. A radio receiver comprising:
a reception unit which receives a signal transmitted from the radio transmitter according to claim 8 to obtain a received signal;
a separation unit which separates the received signal into a first transmission signal and a second transmission signal;
a first demodulation unit which demodulates the separated first transmission signal;
a correction unit which corrects the amplitude of the separated second transmission signal to output the signal while the amplitude of the second transmission signal is decreased and which outputs the separated second transmission signal as it is while the amplitude of the second transmission signal is not decreased; and
a second demodulation unit which demodulates the second transmission signal output from the amplitude correction unit.

18. The radio receiver according to claim 17, further comprising:
a notifying unit which notifies the signal separation unit and the correction unit of the signal constitutions of the first transmission signal and the second transmission signal,
wherein the separation unit is configured to recognize the periods of the first transmission signal and the second transmission signal in the received signal based on the signal constitutions, and
the correction unit is configured to recognize the period in which the amplitude of the second transmission signal is decreased and the period in which the amplitude of the second transmission signal is not decreased based on the signal constitutions.

19. A radio receiver comprising:
a reception unit which receives a signal transmitted from the radio transmitter according to claim 8 to obtain a received signal;
a separation unit which separates the received signal into a first transmission signal and a second transmission signal;
a first correction unit which corrects the amplitude of the separated first transmission signal to output the signal while the amplitude of the first transmission signal is decreased and which outputs the separated second transmission signal as it is while the amplitude of the first transmission signal is not decreased;
a first demodulation unit which demodulates the first transmission signal output from the first amplitude correction unit;
a second correction unit which corrects the amplitude of the separated second transmission signal to output the signal while the amplitude of the second transmission signal is decreased and which outputs the separated second transmission signal as it is while the amplitude of the second transmission signal is not decreased; and
a second demodulation unit which demodulates the second transmission signal output from the second amplitude correction unit.

20. The radio receiver according to claim 19, further comprising:
a notifying unit which notifies the separation unit, the first correction unit and the second correction unit of the signal constitutions of the first transmission signal and the second transmission signal,
wherein the separation unit is configured to recognize the periods of the first transmission signal and the second transmission signal in the received signal based on the signal constitutions,
the first correction unit is configured to recognize the period in which the amplitude of the first transmission signal is decreased and the period in which the amplitude of the first transmission signal is not decreased based on the signal constitutions, and
the second correction unit is configured to recognize the period in which the amplitude of the second transmission signal is decreased and the period in which the amplitude of the second transmission signal is not decreased based on the signal constitutions.
